(19) United States
(12) Patent Application Publication
(10) Pub. No.: US 2009/0002503 A1
(43) Pub. Date: Jan. 1, 2009

(54) IMAGE STABILIZATION UNIT, IMAGE STABILIZATION DEVICE, IMAGING APPARATUS, AND MOBILE DEVICE

(76) Inventors: Shizuo Sekino, Saitama-shi (JP); Hideo Yoshida, Saitama-shi (JP)

Correspondence Address: BIRCH STEWART KOLASCH & BIRCH, PO BOX 747, FALLS CHURCH, VA, 22040-0747, US

(21) Appl. No.: 12/136,432

(22) Filed: Jun. 10, 2008

(30) Foreign Application Priority Data
Jun. 15, 2007 (JP) P2007-159272

(51) Int. Cl. H04N 5/228

(52) U.S. Cl. 348/208.99; 348/374; 455/556.1; 348/E13.074; 348/E05.025

(57) ABSTRACT

Convex portions 2021A and 2021B, which serve as drive points for driving a holding module 202 at the operation time, press concave portions K1 and K2 of two arms ARM1 and ARM2 with urging forces of springs 2022A and 2022B at the non-operation time, thereby making the two arms ARM1 and ARM2 be stationary in positions where the arms ARM1 and ARM2 are located when electric current is turned off.

### CROSS-REFERENCE TO RELATED APPLICATIONS

This application is based upon and claims the benefit of priority from the Japanese Patent Application No. 2007-159272 filed on Jun. 15, 2007; the entire contents of which are incorporated herein by reference.

### BACKGROUND

1. Technical Field

This invention relates to an image stabilization unit that is suitable to be used, as a camera shake compensation mechanisms, in an imaging apparatus of, for example, a digital camera and a mobile phone with a camera, an image stabilization device including the image stabilization unit, an imaging apparatus including the image stabilization device, and a mobile device including the imaging apparatus.

2. Description of the Related Art

JP Hei. 7-274056 A, JP 2005-326807 A (corresponding to US 2005/0225646 A) and Japanese Patent No. 2612371 describe digital cameras or the like that use various camera shake compensation mechanisms in order to suppress blur of captured image caused by user's hands vibrations.

Some of the camera shake compensation mechanisms adopt a system called a gimbal mechanism so that a holding module that holds an imaging lens is rotatable in a pitching direction and a yawing direction.

However, the gimbal mechanism as described in JP Hei. 7-274056 A requires that rotary joints freely rotating be placed in four positions, that is, upper, lower, left and right positions in the holding module. Thus, the size of the camera shake compensation mechanism tends to increase. If an attempt is made to miniaturize the mechanism forcibly, such a disadvantage would arise that bearings, etc., of the rotary joints will become fragile.

Then, Fujinon Corporation filed unpublished Japanese patent applications including Japanese Patent Application Nos. 2006-269712 (corresponding to U.S. patent application Ser. No. 11/864,476), 2006-269713 (corresponding to U.S. patent application Ser. No. 11/905,269), 2006-269714 and 2006-269715 that proposed a drive structure that swingably supports an axis point that is one point on an outer periphery of a holding module and drives the holding module through first and second drive points that are on the outer periphery of the holding module, and are distant from the axis points in first and second directions, respectively, the first and second directions being different from each other. Furthermore, Fujinon Corporation has proposed an image stabilization unit in Japanese Patent Application No. 2007-35341 (corresponding to U.S. patent application Ser. No. 11/972,525) that is a technique for enhancing accuracy in detecting a position of the holding module when the holding module is swinging, with further improving the driving mechanisms described in the above listed unpublished Japanese patent applications. Japanese Patent Application Nos. 2006-269712, 2006-269713, 2006-269714, 2006-269715, and 2007-35341 and U.S. patent application Ser. Nos. 11/864,476, 11/905,269 and 11/972,525 are incorporated herein in those entireties by reference.

Operation of the image stabilization unit that has been proposed in the Japanese patent applications filed by Fujinon Corporation will be described.

FIG. 6 is a drawing to explain the operation of the image stabilization unit.

FIGS. 6(a) and 6(b) show what defective condition in the positional relationship between a lens and a sensor camera shake causes. FIG. 6(c) shows how the image stabilization unit including the lens and the sensor corrects blur.

If no camera shake occurs as shown in FIG. 6(a), an optical axis of the lens and that of a light reception surface (sensor surface) of the sensor match each other and subject light forms an image in a correct position. In contrast, if camera shake occurs, the lens and/or the sensor surface rotate in the arrow direction with respect to each other, and the optical axis of the lens and that of the sensor surface are misaligned. As a result, an image of the subject light is not formed in the correct position as shown in FIG. 6(b).

Then, the image stabilization unit is installed in a mobile device such as a mobile phone with a camera, and when camera shake occurs during photographing, the image stabilization unit including the lens and the sensor is also operated like a gyro as shown in FIG. 6(c). Thereby, the subject light always forms an image in the correct position. If the image stabilization unit is thus installed in the mobile device such as the mobile phone with a camera, even though the mobile device is rotated by a photographing operation, the attitude of the image stabilization unit is always kept in the attitude just before the photographing operation and suitable photographing is performed.

By the way, the holding module is driven using a coil in the above image stabilization unit. Therefore, if electric current for the coil is turned off, the holding module becomes free and may move and produce a sound because of vibration during carrying, which may give to the user an illusion that the mobile device fails. In order to avoid this situation, it is conceivable that added is a stopper structure for preventing the holding module from moving only during carrying. In so doing, it is concerned that the structure will be complicated and gets large. It is conceivable to continue to apply electric current into the coil. In so doing, power consumption increases.

### SUMMARY OF THE INVENTION

The invention has been made in view of the above circumstances and provides a small-sized image stabilization unit having a simple stopper structure for stopping motion of a holding module during carrying, an image stabilization device including the image stabilization unit, an imaging apparatus including the image stabilization device, and a mobile device including the imaging apparatus.

According to a first aspect of the invention, an image stabilization unit includes a holding module, a support member, a first drive mechanism, and a second drive mechanism. The holding module holds a lens. The support member includes a support portion that supports the holding module in an axis point to be swingable in any direction. The axis point is one point on an outer periphery of the holding module. The first drive mechanism drives a first drive point in an optical axis direction. The first drive point is on the outer periphery of the holding module and is distant from the axis point in a first direction being different from the optical axis direction. The second drive mechanism drives a second drive point in the optical axis direction. The second drive point is on the outer periphery of the holding module and is distant from the axis point in a second direction being different from the optical axis direction. The first and second directions are different from each other. The holding module includes spherical convex portions, which are urged in projection directions, in the first and second drive points, respectively. The first drive mechanism includes a spherical concave portion that is pressed by receiving the urged convex portion. The spherical concave portion is provided in a first acting point where the first drive mechanism supports the first drive point to apply a driving force to the first drive point. The second drive mechanism includes a spherical concave portion that is pressed by receiving the urged convex portion. The spherical concave portion is provided in a second acting point where the second drive mechanism supports the second drive point to apply a driving force to the second drive point. The first and second drive mechanisms apply the drive forces to the convex portions through the concave portions, respectively.

With the image stabilization unit of the first aspect of the invention, when the power is turned on so as to bring the image stabilization unit in an operation state, the drive force is applied to the convex portions of the holding module through the concave portions provided in the first drive mechanism and the second drive mechanism, namely, through the first drive point and the second drive point, and the holding module is driven properly. When the power is turned off to bring the image stabilization unit in a non-operation state, the concave portions provided in the first drive mechanism and the second drive mechanism are pressed by the convex portions that serve as the acting points of the urging of the holding module, and the holding module is kept in the final attitude at the driving time.

In so doing, the holding module is held in the final attitude at the driving time by the urging. When a user carries a mobile device including the image stabilization unit, if the holding module were to move and produce a sound, that sound may give to the user an illusion that the mobile device fails. However, the above configuration can prevent this illusion from being given to the user. Also, a stopper is provided with the simple structure of pressing the concave portions against the convex portions by the urging, so that the image stabilization unit does not get large.

In the image stabilization unit of the first aspect, the holding module may be provided with concave portions and the first and second drive mechanisms may be provided with convex portions.

That is, according to a second aspect of the invention, an image stabilization unit includes a holding module, a support member, a first drive mechanism and a second drive mechanism. The holding module holds a lens. The support member includes a support portion that supports the holding module in an axis point to be swingable in any direction. The axis point is one point on an outer periphery of the holding module. The first drive mechanism drives a first drive point in an optical axis direction. The first drive point is on the outer periphery of the holding module and is distant from the axis point in a first direction being different from the optical axis direction. The second drive mechanism drives a second drive point in the optical axis direction. The second drive point is on the outer periphery of the holding module and is distant from the axis point in a second direction being different from the optical axis direction. The first and second directions are different from each other. The holding module includes spherical concave portions, which are urged in projection directions, in the first and second drive points, respectively. The first drive mechanism includes a spherical convex portion that is pressed by receiving the urged concave portion. The spherical convex portion is provided in a first acting point where the first drive mechanism supports the first drive point to apply a driving force to the first drive point. The second drive mechanism includes a spherical convex portion that is pressed by receiving the urged concave portion. The spherical convex portion is provided in a second acting point where the second drive mechanism supports the second drive point to apply a driving force to the second drive point. The first and second drive mechanisms apply the drive forces to the concave portions through the convex portions, respectively.

If any of the first and second aspects described above is applied to Japanese Patent Application No. 2007-35341 (corresponding to U.S. patent application Ser. No. 11/972,525), which was filed by Fujinon Corporation, further advantages can be achieved.

Preferably, the following configuration is employed. That is, the first drive mechanism includes a first arm, a first coil, a first magnet and a first guide member. The first arm includes the first acting point and rotatably supports the first drive point. The first coil is held by the first arm and generates the drive force in the optical axis direction upon reception of action of a magnetic force and electric current so as to cause the first arm to drive the first drive point in the optical axis direction. The first magnet is held by the support member, applies the magnetic force to the first coil, and spreads in parallel to the optical axis. The first guide member is fixed to the support member and guides the first arm so that the first acting point, which applies the drive force to the first drive point, moves in the optical axis direction. The second drive mechanism includes a second arm, a second coil, a second magnet and a second guide member. The second arm includes the second acting point and rotatably supports the second drive point. The second coil is held by the second arm and generates the drive force in the optical axis direction upon reception of action of a magnetic force and electric current so as to cause the second arm to drive the second drive point in the optical axis direction. The second magnet is held by the support member, applies the magnetic force to the second coil, and spreads in parallel to the optical axis. The second guide member is fixed to the support member and guides the second arm so that the second acting point, which applies the drive force to the second drive point, moves in the optical axis direction.

Also, the following configuration is more preferable. That is, the image stabilization unit further includes a first sensor and a second sensor. The first sensor is supported by the first arm and detects change in the magnetic force received from the first magnet. The change in the magnetic force is caused by movement of the first arm in the optical axis direction when the first arm drives the first drive point. The second sensor is supported by the second arm and detects change in the magnetic force received from the second magnet. The change in the magnetic force is caused by movement of the second arm in the optical axis direction when the second arm drives the second drive point.

Also, it is preferable that the holding module holds an image sensor that captures subject light to generate an image signal, as well as the lens.

Also, it is preferable that the first drive point and the second drive point are formed in such positions that a line connecting the first drive point and the axis point and a line connecting the second drive point and the axis point intersect at an angle of about 90 degrees.

Furthermore, it is preferable that the holding module includes a spherical convex portion in the axis point, and that the support member includes, in the support portion, a spherical concave surface that receives the convex portion of the holding module.

According to another aspect of the invention, an image stabilization device includes any of the image stabilization units described above, a vibration detection sensor and a vibration control section. The vibration detection section detects vibration. The vibration control section causes the first and second drive mechanisms to drive and rotate the holding module in accordance with a detection result of the vibration detection section.

Also, according to further another aspect of the invention, an imaging apparatus includes the above image stabilization device. The holding module holds an image sensor that captures subject light to generate an image signal, as well as the lens. The image sensor generates the image signal in which blur is decreased by operation of the image stabilization device.

According to still further another aspect of the invention, A mobile device includes the above imaging apparatus.

With any of the above set forth configurations, there are provided the small image stabilization unit having the simple stopper structure for stopping a motion of the holding motion during carrying, the image stabilization device including the image stabilization unit, the imaging apparatus including the image stabilization device, and the mobile device including the imaging apparatus.

### BRIEF DESCRIPTION OF THE DRAWINGS

FIGS. 1(A) and 1(B) are perspective views showing an outer appearance of a mobile phone to which an embodiment of the invention is applied.

FIG. 2 is a block diagram showing the internal configuration of the mobile phone 100 shown in FIG. 1.

FIG. 3 is an exploded perspective view of an image stabilization unit.

FIG. 4 is a drawing showing a state after the respective members shown in the exploded perspective view of FIG. 3 are assembled into the image stabilization unit.

FIG. 5 is a drawing for explaining the operation of springs for making arms be stationary in predetermined positions.

FIGS. 6(A) to 6(C) are drawings for explaining the operation of an image stabilization unit in a related art.

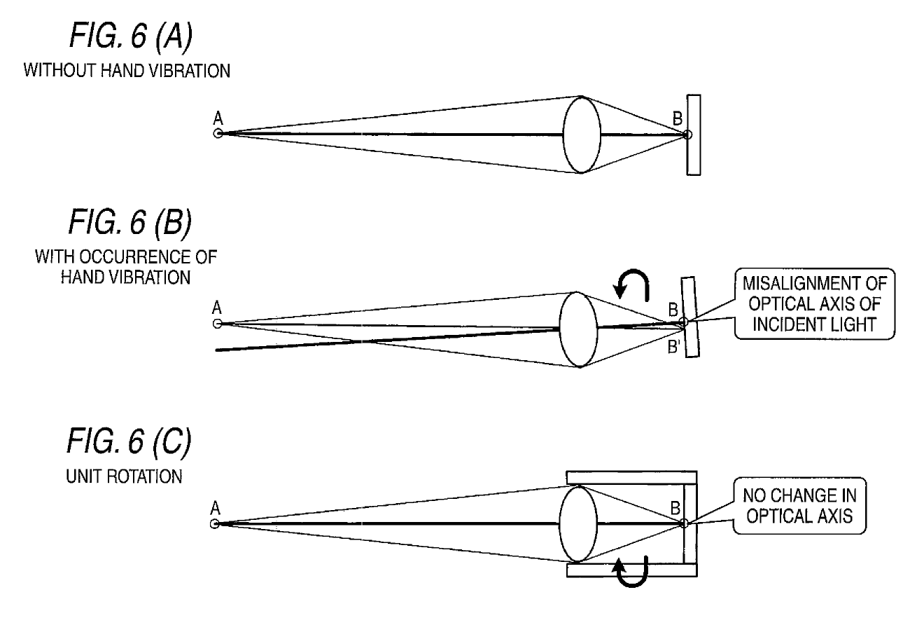

### DETAILED DESCRIPTION OF EMBODIMENTS OF THE INVENTION

Referring now to the accompanying drawings, there is shown an embodiment of the invention.

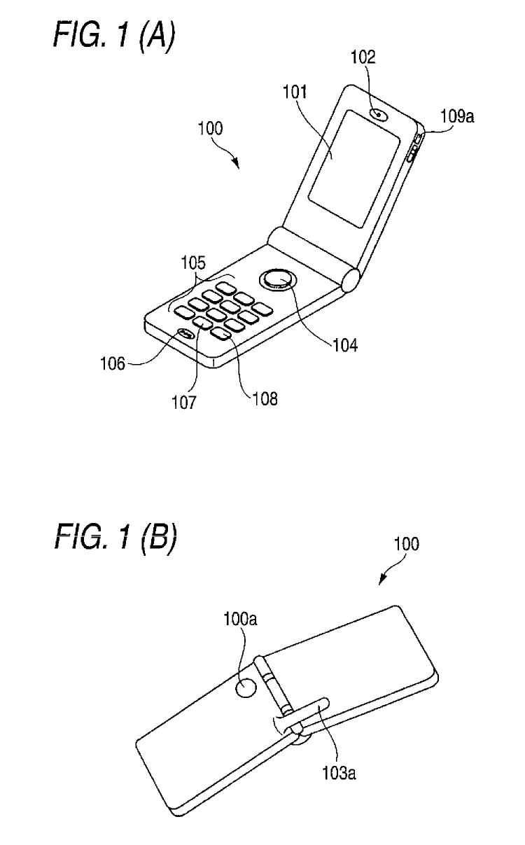

FIG. 1 is an external perspective view of a mobile phone incorporating an embodiment of the invention.

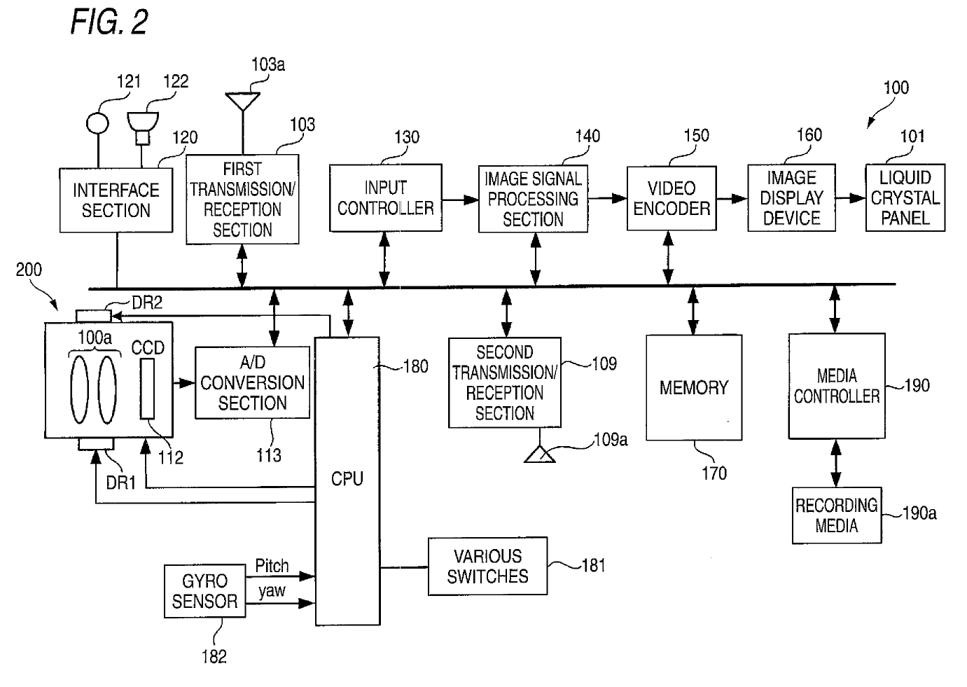

FIG. 1(A) shows a front view of a mobile phone 100. A liquid crystal panel 101 for displaying a menu screen, a taken image, etc., is provided in the front surface of the mobile phone 100, and a speaker (see FIG. 2) is provided inside the mobile phone 100. The mobile phone 100 also includes: an earpiece 102 for outputting sound, which is produced from the speaker, to space; a selection button 104, which is used to select various functions and is used as a shutter button to taking an image; push buttons 105 for entering a telephone number; a mouth piece 106, which is provided with a microphone (see FIG. 2) therein and transmits voice to the microphone; an acknowledgement button 107 for acknowledging the telephone number entered by a user, etc.; a power button 108; and a second antenna 109a for transmitting and receiving an image and address information by short-distance wireless communications not via a telephone station.

FIG. 1(B) shows a rear view of the mobile phone 100. A first antenna 103a for transmitting and receiving sound and data such as mail via the telephone station and an imaging lens 100a are provided in the rear surface of the mobile phone 100. The imaging lens 100a is held by an image stabilization unit which will be described later.

FIG. 2 is a block diagram showing the internal configuration of the mobile phone 100 shown in FIG. 1.

The mobile phone 100 includes therein an image stabilization unit 200, an A/D (analog/digital) conversion section 113, a microphone 121, a speaker 122, an interface section 120, the first antenna 103a, a first transmission/reception section 103, an input controller 130, an image signal processing section 140, a video encoder 150, an image display device 160, the second antenna 109a, a second transmission/reception section 109, memory 170, a CPU 180, a media controller 190, and various switches 181 including the selection button 104 and the push buttons 105 shown in FIG. 1. Furthermore a recording medium 190a is connected thereto. In this embodiment, the image stabilization unit 200, the CPU 180, a gyro sensor 182, and a driver DR make up an example of an image stabilization device of the invention. Also, the image stabilization device, the input controller 130, the image signal processing section 140, the video encoder 150, the image display device 160, the liquid crystal panel 101, the media controller 190, and the recording medium 190a make up an example of an imaging apparatus of the invention.

The CPU 180 sends processing commands to the respective components of the mobile phone 100 shown in FIG. 2 to control the respective components. For example, if the user presses the selection button 104 shown in FIG. 1 in a state where a photographing mode for taking a photograph is set, the CPU 180 sends a certain command to a CCD 112 provided in the image stabilization unit 200 and sends another certain command to the driver DR so as to swing a holding module (described later) provided in the image stabilization unit 200 in a direction of canceling camera shake detected by the gyro sensor 182, and a photograph is taken while the camera shake is compensated. The configuration of the image stabilization unit 200 will be described later in detail.

In response to pressing of the selection button 104 shown in FIG. 1(A), the CPU 180 sets an electronic shutter for the CCD 112 in the image stabilization unit 200 and starts an imaging process.

At this time, a direction of camera shake when the user presses the selection button 104 is detected by the gyro sensor 182 and is notified to the CPU 180. Upon reception of the detection result of the gyro sensor 182, the CPU 180 notifies a correction direction to the driver DR and takes a photograph while causing the driver DR, which receives the notification, to drive a coil (described later) of the image stabilization unit 200 to swing the holding module (described later) of the image stabilization unit 200 in response to the camera shake. Thus, the camera shake, which occurs when the user presses the selection button 104, is compensated and an image of subject light is formed on the CCD 112 without blur.

The CCD 112 receives subject light that passes through the imaging lens 100a during the shutter time of the electronic shutter and reads the subject image, which is based on the subject light, as a subject signal that is an analog signal. The subject signal generated in the CCD 112 is converted into digital photograph image data by the A/D conversion section 113, and the photograph image data is sent through the input controller 130 to the image signal processing section 140.

The image signal processing section 140 performs image processing such as RGB level adjustment and gamma adjustment for the image data and further performs a compression process for the image data, which is subjected to the image processing. The compressed image data is once sent to the memory 170.

The memory 170 includes a SDRAM that has high recording speed, stores a program executed in the mobile phone 100 and is used as an intermediate buffer, a SRAM that is a data storage memory for storing data for various menu screens, user's settings, etc., and a VRAM for storing the compressed image data. The VRAM is divided into areas. Image data are stored in the areas in order and are read in order to the video encoder 150 and the media controller 190.

The video encoder 150 acquires the compressed image data from the memory 170 in accordance with a command from the CPU 180 and converts the compressed image data into a data format that can be displayed on the liquid crystal panel 101. The decoded image data is sent to the image display device 160, which then displays an image represented by the image data on the liquid crystal panel 101. The media controller 190 records the compressed image data, which is stored in the memory 170, into the recording medium 190a and/or reads the image data recorded on the recording medium 190a.

When the user enters a telephone number with the push buttons 105 shown in FIG. 1(A) and presses the acknowledgement button 107, the telephone number is set and communication with the other party is started. At this time, communication information such as the telephone number of the mobile phone 100 and the entered telephone number is sent from the CPU 180 to the first transmission/reception section 103 and is converted into a radio wave, and the radio wave is sent to the first antenna 103a and is emitted from the first antenna 103a. The radio wave emitted from the first antenna 103a is sent to a telephone station via community antennas (not shown) provided in various places such as buildings and telephone poles, and connection to the other party to which the specified telephone number is assigned is established in the telephone station.

When the connection to the other party is established, user's voice being emitted toward the mobile phone 100 is collected by the microphone 121 and the interface section 120 converts the collected voice into a radio wave that represents sound data. The first antenna 103a of the first transmission/reception section 103 transmits the radio wave to the other party through. The interface section 120 also converts a radio wave for sound (voice) received through the first antenna 103a into sound (voice) data, and the converted sound (voice) data is emitted as sound (voice) from the speaker 122. In the first transmission/reception section 103 and the first antenna 103a, not only the sound (voice) data, but also mail data representing a mail is transmitted and received using a mail address instead of the telephone number. The mail data, which is received at the first antenna 103a and converted into digital data by the first transmission/reception section 103, is stored in the memory 170 by the input controller 130.

Also, the mobile phone 100 includes a wireless communication interface (second transmission/reception section 109, second antenna 109a) for communicating by short-distance wireless communications not via a telephone station as well as the communication interface (first transmission/reception section 103, first antenna 103a) for communicating with another apparatus such as another mobile phone via the telephone station. Infrared communications, Bluetooth, etc., may be applied as the communication interface for short-distance wireless communications. In this embodiment, the infrared communications are applied as the communication interface. If infrared radiation that is directly transmitted from another mobile phone is received at the second antenna 109a, an electric signal based on the received infrared radiation is picked up by the second transmission/reception section 109 and is converted into digital data. Conversely, when data is transmitted to an external apparatus, the data is sent to the second transmission/reception section 109, which then converts the data into a radio wave and emits the radio wave from the second antenna 109a.

When infrared radiation representing an image is received at the second antenna 109a, the second transmission/reception section 109 converts an electric signal, which is based on the infrared radiation, into image data. Like photograph image data, the thus-obtained image data is sent to the image display device 160, and an image represented by the image data is displayed on the liquid crystal panel 101 and is recorded on the recording medium 190a through the media controller 190.

The mobile phone 100 is basically configured as described above.

Subsequently, the configuration of the image stabilization unit 200, which constitutes a part of the imaging apparatus provided in the mobile phone 100, will be described in detail.

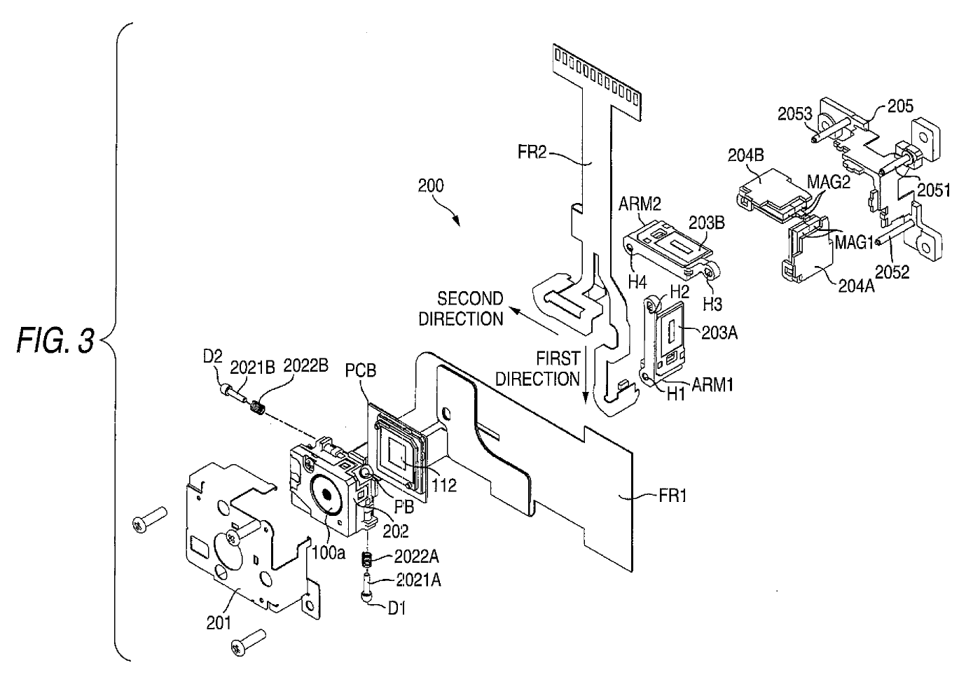

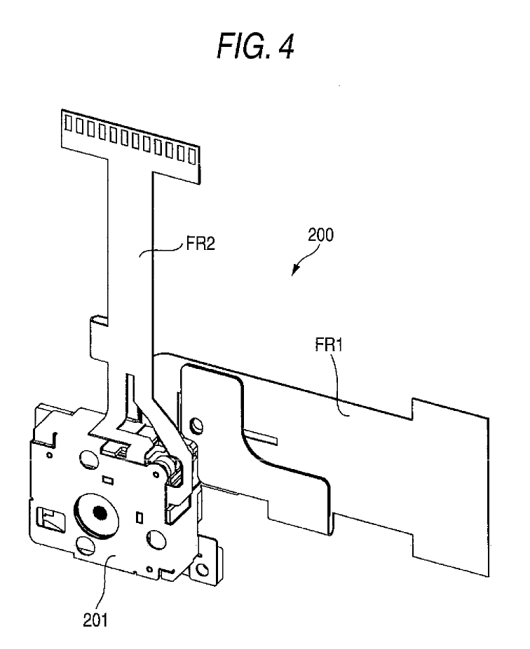

FIG. 3 is an exploded perspective view of the image stabilization unit 200. FIG. 4 is a drawing showing the image stabilization unit 200 into which the respective members shown in the exploded perspective view of FIG. 3 are assembled.

In FIGS. 3 and 4, the lower left portion corresponds to the subject side.

FIG. 3 shows, in order from the lower left subject side in a disassembled state, a cover 201, a holding module 202, a flexible board FR1 for image signal transfer, a flexible board FR2 for applying electric current into coils formed on a board 203A extending in a first direction shown in FIG. 3 and a board 203B extending in a second direction shown in FIG. 3, a pair of arms ARM1 and ARM2 for respectively holding the boards 203A and 203B, U-shaped yokes 204A and 204B for holding magnets MAG1 and MAG2 in which N and S poles are arranged so as to face the coils formed on the boards 203A and 203B, and a support member 205 for movably supporting the two arms ARM1 and ARM2 and fixing the two yokes 204A and 204B onto respective surfaces extending in the first direction and the second direction. These components are assembled into a shape shown in FIG. 4.

First, the configuration will be described with reference to FIG. 3.

On the rightmost side of FIG. 3, shown is the support member 205 that has a dogleg shape and supports two drive mechanisms for swinging the holding module 202. The support member 205 supports the two drive mechanisms for swinging the holding module 202 while supporting the holding module 202.

The support member 205 is provided with three guide members 2051, 2052, and 2053 that are inserted into holes H1, H2, H3, and H4 formed in both end portions of the two arms ARM1 and ARM2. The guide members 2051 to 2053 are provided in apexes of the support member 205 having the dogleg shape. The center guide member 2051 is inserted into the holes H2 and H3 of the holes in the both end portions of the two arms ARM1 and ARM2 in common.

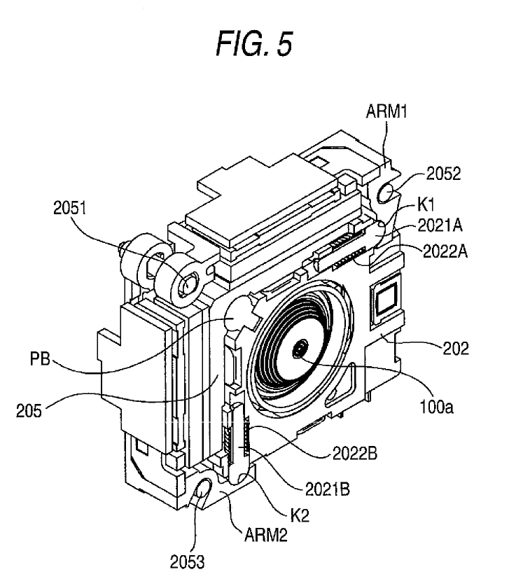

That is, inserted into one arm ARM1 are the guide member 2051 being located at the apex of the center of the dogleg shape of the support member 205 and the guide member 2052 being located at the apex on one end side of the dogleg shape. Also, inserted into the other arm ARM2 are the guide member 2051 being located at the apex of the center of the dogleg shape and the guide member 2053 being located at the apex on the other end side of the dogleg shape. As shown in FIGS. 3 and 5, concave portions K1 and K2 are respectively provided on the holding-module side of one end portions (around the holes H1 and H4) of the arms ARM1 and ARM2 to be configured to engage with spherical convex portions provided in one end portions of rod members 2021A and 2021B (which will be described in detail later).

The U-shaped yokes 204A and 204B are adhered and fixed onto surfaces of the support member 205 that extend in the first direction and the second direction in FIG. 3 from the apex of the dogleg shape of the support member 205. The U-shaped yokes 204A and 204B are disposed so that those openings face toward the boards 203A and 203B formed with the coils. Therefore, the boards 203A and 203B are housed from the respective opening sides so as to become parallel to the magnets MAG1 and MAG2. The flexible board FR2 for applying electric current to the coils on the boards 203A and 203B is connected to the boards 203A and 203B. Each of the boards 203A and 203B being formed with the coils includes a hole element for detecting a position of the holding module 202 that swings in response to motion of the arms ARM1 and ARM2.

Also, a concave portion is provided on the holding-module side of the apex portion the dogleg shape of the support member 205 so as to be configured to engage with a spherical convex portion PB of the holding module. Therefore, if the respective components are assembled so that the convex portion PB of the holding module 202 engages with the concave portion and the spherical concave portions K1 and K2 provided in the two arms being movably supported by the support member 205 engage with the convex portion of a first drive point D1 of the holding module 202 and a convex portion of a second drive point D2 of the holding module 202, the holding module 202 is swingably supported by the support member 205 as shown in FIG. 4.

In this example, the support member 205, the arm ARM1, the board 203A formed with the coil, and the yoke 204A with the magnet MAG1 being attached thereon make up an example of a first drive mechanism of the invention. Also, the support member 205, the arm ARM2, the board 203B being formed with the coil, and the yoke 204B with the magnet MAG2 being attached thereon make up an example of a second drive mechanism of the invention.

Furthermore, in order to show the first drive point D1 and the second drive point D2, FIG. 3 shows the rod members 2021A and 2021B having the spherical convex portions and springs 2022A and 2022B into which the rod members 2021A and 2021B are inserted.

Each of the springs 2022A and 2022B has (i) a function of generating an adequate contact force in a joint portion between the convex portion (first drive point D1, second drive point D2) provided in the holding module 202 and the concave portion (K1, K2) of the arm (ARM1, ARM2) to enhance a drive performance when electric current is applied to the coil and (ii) a function of pressing the convex portion (first drive point D1, second drive point D2) against the concave portion (K1, K2) of the arm (ARM1, ARM2) by the urging force of the spring (2022A, 2022B) when electric current is not applied to the coil, thereby making the arm be stationary in a position, where the arm is located at a time when energizing of the coil is turned off, after the energizing of the coil is turned off.

FIG. 5 is a drawing for explaining the operation of the springs 2022A and 2022B.

FIG. 5 shows that the convex portions of the holding module 202, which also serve as the drive point, press the concave portions K1 and K2 of the two arms ARM1 and ARM2 with the urging forces of the springs 2022A and 2022B after the energizing of the coil is turned off, thereby holding the two arms ARM1 and ARM2 in the positions at a time when the energizing of the coil is turned off.

That is, the holding module 202 has the spherical convex portions, which are urged in the projection directions, in the first drive point D1 and the second drive point D2, respectively. The first arm ARM1 includes the spherical concave portion K1 that is pressed by receiving the urged convex portion and that is provided in a first acting point. The second arm ARM2 includes the spherical concave portion K2 that is pressed by the urged convex portion and that is provided in a second acting point. The first arm ARM1 and the second arm ARM2 apply drive forces to the respective convex portions through the concave portions K1 and K2, respectively. With this structure, when the power is turned off, the concave portions K1 and K2 of the arms ARM1 and ARM2 are pressed by the convex portions of the holding module 202, and the holding module 202 is held at a position at a time when the power is turned off. When a user carries the mobile device having the image stabilization unit, if the holding module were to move and produce a sound, that sound may give to the user an illusion that the mobile device fails. However, the above configuration can prevent the illusion from being given to the user.

In the example, the configuration the holding module 202 is configured to hold the CCD 112 as well as the lens. Thus, the flexible board FR1 for image signal transfer is connected to the holding module 202 that swings. The flexible board FR1 is connected at one end to a sensor board PCB on which the CCD 112 is mounted, so that a portion of the flexible board FR1 at least initially extending from the sensor board PCB extends in a slanting direction with respect to both the first direction connecting the axis point PB and the first drive point D1 and the second direction connecting the axis point PB and the second drive point D2 and toward the outside from the holding module 202. With this configuration, the swinging is not much transmitted to the flexible board FR1.

In this embodiment, described is an example in which the holding module is provided with the convex portions and the arms are provided with the concave portions to form the joint portions. However, the holding module may be provided with the concave portions and the arms may be provided with the convex portions to form the joint portions.

As described above, according to the invention, there are provided a small-sized image stabilization unit having a simple stopper structure for stopping a motion of a holding module during carrying, an image stabilization device including the image stabilization unit, a imaging apparatus including the image stabilization device, and a mobile device including the imaging apparatus.

What is claimed is:

1. An image stabilization unit comprising:
a holding module that holds a lens;
a support member including a support portion that supports the holding module in an axis point to be swingable in any direction, wherein the axis point is one point on an outer periphery of the holding module;
a first drive mechanism that drives a first drive point in an optical axis direction, wherein the first drive point is on the outer periphery of the holding module and is distant from the axis point in a first direction being different from the optical axis direction; and
a second drive mechanism that drives a second drive point in the optical axis direction, wherein
the second drive point is on the outer periphery of the holding module and is distant from the axis point in a second direction being different from the optical axis direction,
the first and second directions are different from each other,
the holding module includes spherical convex portions, which are urged in projection directions, in the first and second drive points, respectively,
the first drive mechanism includes a spherical concave portion that is pressed by receiving the urged convex portion, the spherical concave portion being provided in a first acting point where the first drive mechanism supports the first drive point to apply a driving force to the first drive point,
the second drive mechanism includes a spherical concave portion that is pressed by receiving the urged convex portion, the spherical concave portion being provided in a second acting point where the second drive mechanism supports the second drive point to apply a driving force to the second drive point, and
the first and second drive mechanisms apply the drive forces to the convex portions through the concave portions, respectively.

2. The image stabilization unit according to claim 1, wherein
the first drive mechanism comprises:
a first arm that includes the first acting point and rotatably supports the first drive point;
a first coil that is held by the first arm and generates the drive force in the optical axis direction upon reception of action of a magnetic force and electric current so as to cause the first arm to drive the first drive point in the optical axis direction;
a first magnet that is held by the support member, applies the magnetic force to the first coil, and spreads in parallel to the optical axis; and
a first guide member that is fixed to the support member and guides the first arm so that the first acting point, which applies the drive force to the first drive point, moves in the optical axis direction, and
the second drive mechanism comprises:
a second arm that includes the second acting point and rotatably supports the second drive point;
a second coil that is held by the second arm and generates the drive force in the optical axis direction upon reception of action of a magnetic force and electric current so as to cause the second arm to drive the second drive point in the optical axis direction;
a second magnet that is held by the support member, applies the magnetic force to the second coil, and spreads in parallel to the optical axis; and
a second guide member that is fixed to the support member and guides the second arm so that the second acting point, which applies the drive force to the second drive point, moves in the optical axis direction.

3. The image stabilization unit according to claim 2, further comprising:
a first sensor that is supported by the first arm and detects change in the magnetic force received from the first magnet, the change in the magnetic force being caused by movement of the first arm in the optical axis direction when the first arm drives the first drive point; and
a second sensor that is supported by the second arm and detects change in the magnetic force received from the second magnet, the change in the magnetic force being caused by movement of the second arm in the optical axis direction when the second arm drives the second drive point.

4. The image stabilization unit according to claim 1, wherein the holding module holds an image sensor that captures light from a subject to generate an image signal, as well as the lens.

5. The image stabilization unit according to claim 1, wherein the first drive point and the second drive point are formed in such positions that a line connecting the first drive point and the axis point and a line connecting the second drive point and the axis point intersect at an angle of about 90 degrees.

6. The image stabilization unit according to claim 1, wherein
the holding module includes a spherical convex portion in the axis point, and
the support member includes, in the support portion, a spherical concave surface that receives the convex portion of the holding module.

7. An image stabilization device comprising:
the image stabilization unit according to claim 1;
a vibration detection section that detects vibration; and
a vibration control section that causes the first and second drive mechanisms to drive and rotate the holding module in accordance with a detection result of the vibration detection section.

8. An imaging apparatus comprising:
the image stabilization device according to claim 7, wherein
the holding module holds an image sensor that captures light from a subject to generate an image signal, as well as the lens, and
the image sensor generates the image signal in which blur is decreased by operation of the image stabilization device.

9. A mobile device comprising the imaging apparatus according to claim 8.

10. An image stabilization unit comprising:
a holding module that holds a lens;
a support member including a support portion that supports the holding module in an axis point to be swingable in any direction, wherein the axis point is one point on an outer periphery of the holding module;
a first drive mechanism that drives a first drive point in an optical axis direction, wherein the first drive point is on the outer periphery of the holding module and is distant from the axis point in a first direction being different from the optical axis direction; and
a second drive mechanism that drives a second drive point in the optical axis direction, wherein
the second drive point is on the outer periphery of the holding module and is distant from the axis point in a second direction being different from the optical axis direction,
the first and second directions are different from each other,
the holding module includes spherical concave portions, which are urged in projection directions, in the first and second drive points, respectively,
the first drive mechanism includes a spherical convex portion that is pressed by receiving the urged concave portion, the spherical convex portion being provided in a first acting point where the first drive mechanism supports the first drive point to apply a driving force to the first drive point,
the second drive mechanism includes a spherical convex portion that is pressed by receiving the urged concave portion, the spherical convex portion being provided in a second acting point where the second drive mechanism supports the second drive point to apply a driving force to the second drive point, and
the first and second drive mechanisms apply the drive forces to the concave portions through the convex portions, respectively.

11. The image stabilization unit according to claim 10, wherein
the first drive mechanism comprises:
a first arm that includes the first acting point and rotatably supports the first drive point;
a first coil that is held by the first arm and generates the drive force in the optical axis direction upon reception of action of a magnetic force and electric current so as to cause the first arm to drive the first drive point in the optical axis direction;
a first magnet that is held by the support member, applies the magnetic force to the first coil, and spreads in parallel to the optical axis; and
a first guide member that is fixed to the support member and guides the first arm so that the first acting point, which applies the drive force to the first drive point, moves in the optical axis direction, and
the second drive mechanism comprises:
a second arm that includes the second acting point and rotatably supports the second drive point;
a second coil that is held by the second arm and generates the drive force in the optical axis direction upon reception of action of a magnetic force and electric current so as to cause the second arm to drive the second drive point in the optical axis direction;
a second magnet that is held by the support member, applies the magnetic force to the second coil, and spreads in parallel to the optical axis; and
a second guide member that is fixed to the support member and guides the second arm so that the second acting point, which applies the drive force to the second drive point, moves in the optical axis direction.

12. The image stabilization unit according to claim 11, further comprising:
a first sensor that is supported by the first arm and detects change in the magnetic force received from the first magnet, the change in the magnetic force being caused by movement of the first arm in the optical axis direction when the first arm drives the first drive point; and
a second sensor that is supported by the second arm and detects change in the magnetic force received from the second magnet, the change in the magnetic force being caused by movement of the second arm in the optical axis direction when the second arm drives the second drive point.

13. The image stabilization unit according to claim 10, wherein the holding module holds an image sensor that captures light from a subject to generate an image signal, as well as the lens.

14. The image stabilization unit according to claim 10, wherein the first drive point and the second drive point are formed in such positions that a line connecting the first drive point and the axis point and a line connecting the second drive point and the axis point intersect at an angle of about 90 degrees.

15. The image stabilization unit according to claim 10, wherein
the holding module includes a spherical convex portion in the axis point, and
the support member includes, in the support portion, a spherical concave surface that receives the convex portion of the holding module.

16. An image stabilization device comprising:
the image stabilization unit according to claim 10;
a vibration detection section that detects vibration; and
a vibration control section that causes the first and second drive mechanisms to drive and rotate the holding module in accordance with a detection result of the vibration detection section.

17. An imaging apparatus comprising:
the image stabilization device according to claim 16, wherein
the holding module holds an image sensor that captures light from a subject to generate an image signal, as well as the lens, and
the image sensor generates the image signal in which blur is decreased by operation of the image stabilization device.

18. A mobile device comprising the imaging apparatus according to claim 17.
